(19) United States
(12) Patent Application Publication
(10) Pub. No.: US 2026/0232158 A1
(43) Pub. Date: Aug. 13, 2026

(54) ROBOT CLEANER AND CLEANING METHOD THEREFOR

(71) Applicant: SAMSUNG ELECTRONICS CO., LTD., Suwon-si (KR)

(72) Inventors: Jiwoong IM, Suwon-si (KR); Muwoong LEE, Suwon-si (KR); Boseok MOON, Suwon-si (KR); Koeun CHOI, Suwon-si (KR)

(73) Assignee: SAMSUNG ELECTRONICS CO., LTD., Suwon-si (KR)

(21) Appl. No.: 19/638,841

(22) Filed: Apr. 3, 2026

Related U.S. Application Data
(63) Continuation of application No. PCT/KR2024/021144, filed on Dec. 26, 2024.

(30) Foreign Application Priority Data
Jan. 4, 2024 (KR) 10-2024-0001454

(51) Int. Cl. A47L 9/28; G06T 7/73

(52) U.S. Cl. CPC A47L 9/2852; G06T 7/73; A47L 2201/04; A47L 2201/06; G06T 2207/10004; G06T 2207/30241

(57) ABSTRACT

A robot cleaner is disclosed. The robot cleaner robot cleaner includes a sensor, a driver, at least one memory storing instructions, and at least one processor. The robot cleaner identifies a door pad attached to a door by using the sensor when the door of a region in which the robot cleaner is positioned is in an opened state, controls the driver to move the robot cleaner to come into contact with the door pad, and controls the driver to rotate the robot cleaner while the robot cleaner is in contact with the door pad to allow the door to be rotated.

### CROSS-REFERENCE TO RELATED APPLICATION(S)

This application is a continuation of International Application No. PCT/KR2024/021144, filed on December 26, 2024, which is based on and claims priority to Korean Patent Application No. 10-2024-0001454, filed on January 4, 2024, the disclosures of which are incorporated by reference herein in their entireties.

### BACKGROUND

### 1. Field

The present disclosure relates to a robot cleaner for cleaning a space and a cleaning method therefor.

### 2. Description of Related Art

Robots may sense a surrounding environment in real time based on sensors, cameras, and the like, collect information, and autonomously travel, in addition to simple repetitive functions. Such robots are currently used in many fields, and robot cleaners are widely used in homes.

A robot cleaner may travel in a space (e.g., an indoor space) and clean the space by vacuuming foreign substances and the like. Meanwhile, a space between an entrance and a wall surface is unable to be cleaned by the robot cleaner when the entrance is closed during a process of cleaning the space.

### SUMMARY

According to an aspect of the disclosure, there is provided a robot cleaner including: a sensor; a driver; at least one memory storing instructions; and at least one processor, wherein the instructions, when executed by the at least one processor, cause the robot cleaner to: identify a door pad attached to a door by using the sensor when the door of a region in which the robot cleaner is positioned is in an opened state; control the driver to move the robot cleaner to come into contact with the door pad; and control the driver to rotate the robot cleaner while the robot cleaner is in contact with the door pad to allow the door to be rotated.

The sensor may include a camera, and wherein the instructions, when executed by the at least one processor, may cause the robot cleaner to: obtain an image in which the door is captured by using the camera; and identify the door pad attached to a lower region of the door based on the obtained image.

The sensor may include a camera, and wherein the instructions, when executed by the at least one processor, may cause the robot cleaner to: obtain an image in which the door is captured by using the camera; identify a position at which the door is installed in an entrance based on the obtained image; and control the driver to rotate the robot cleaner in a rotation direction corresponding to the identified position while the robot cleaner is in contact with the door pad.

The door may be rotated about a rotation axis due to the rotation of the robot cleaner, and wherein the instructions, when executed by the at least one processor, may cause the robot cleaner to: control the driver to move the robot cleaner into a space between the door and a wall surface formed by rotation of the door; and control the driver to allow the robot cleaner to push the door pad.

The sensor may include a camera, and wherein the instructions, when executed by the at least one processor, may cause the robot cleaner to: obtain an image in which the door is captured by using the camera; identify a rotation angle of the door based on the obtained image; identify whether the robot cleaner is physically capable of entering the space between the door and the wall surface based on the identified rotation angle; and control the driver to move the robot cleaner into the space between the door and the wall surface when the robot cleaner is identified as being physically capable of entering the space between the door and the wall surface.

The sensor may include a camera, and wherein the instructions, when executed by the at least one processor, may cause the robot cleaner to: obtain an image in which the door is captured by using the camera; identify a size of the door based on the obtained image; identify a movement trajectory of the door pad based on the size of the door with respect to the rotation axis of the door; and control the driver to allow the robot cleaner to push the door pad based on the identified movement trajectory.

The instructions, when executed by the at least one processor, may cause the robot cleaner to: generate a circle having a center at the rotation axis of the door and a radius corresponding to the size of the door; and identify, as the movement trajectory of the door pad, a trajectory on a circumference of the generated circle from a position of the door pad to a position of an entrance.

According to an aspect of the disclosure, there is provided a cleaning method for a robot cleaner including a sensor, the cleaning method including: identifying a door pad attached to a door by using the sensor when the door of a region in which the robot cleaner is positioned is in an opened state; moving the robot cleaner to come into contact with the door pad; and rotating the robot cleaner while the robot cleaner is in contact with the door pad to allow the door to be rotated.

The sensor may include a camera, and wherein the identifying of the door pad may include: obtaining an image in which the door is captured by using the camera; and identifying the door pad attached to a lower region of the door based on the obtained image.

The sensor may include a camera, and wherein the rotating of the robot cleaner may include: obtaining an image in which the door is captured by using the camera; identifying a position at which the door is installed in an entrance based on the obtained image; and rotating the robot cleaner in a rotation direction corresponding to the identified position while the robot cleaner is in contact with the door pad.

The door may be rotated about a rotation axis due to the rotation of the robot cleaner, wherein the cleaning method further may include: moving the robot cleaner into a space between the door and a wall surface formed by rotation of the door; and moving the robot cleaner to push the door pad.

The sensor may include a camera, and wherein the moving of the robot cleaner may include: obtaining an image in which the door is captured by using the camera; identifying a rotation angle of the door based on the obtained image; identifying whether the robot cleaner is physically capable of entering the space between the door and the wall surface based on the identified rotation angle; and moving the robot cleaner into the space between the door and the wall surface when the robot cleaner is identified as being physically capable of entering the space between the door and the wall surface.

The sensor may include a camera, and wherein the pushing of the door pad may include: obtaining an image in which the door is captured by using the camera; identifying a size of the door based on the obtained image; identifying a movement trajectory of the door pad based on the size of the door with respect to the rotation axis of the door; and moving the robot cleaner to push the door pad based on the identified movement trajectory.

The identifying of the movement trajectory of the door pad may include: generating a circle having a center at the rotation axis of the door and a radius corresponding to the size of the door; and identifying, as the movement trajectory of the door pad, a trajectory on a circumference of the generated circle from a position of the door pad to a position of an entrance.

### BRIEF DESCRIPTION OF THE DRAWINGS

The above and other aspects and/or features of embodiments of the disclosure will become more apparent from the following detailed description taken in conjunction with the accompanying drawings, in which:

FIG. 1 is a view schematically illustrating a robot cleaner according to an embodiment of the present disclosure.

FIG. 2A is a block diagram illustrating a configuration of the robot cleaner according to an embodiment of the present disclosure.

FIG. 2B is a block diagram illustrating a configuration of the robot cleaner according to an embodiment of the present disclosure.

FIG. 3 is a flowchart illustrating an operation in which the robot cleaner closes a door due to rotation of the robot cleaner according to an embodiment of the present disclosure.

FIG. 4 is a view illustrating an example of a door pad according to an embodiment of the present disclosure.

FIGS. 5A and 5B are views illustrating an example of an operation in which the robot cleaner rotates the door due to rotation of the robot cleaner according to an embodiment of the present disclosure.

FIG. 6 is a flowchart illustrating an operation in which the robot cleaner closes the door by pushing the door pad attached to the door after rotation of the door according to an embodiment of the present disclosure.

FIGS. 7A and 7B are views illustrating an example in which the robot cleaner moves to a space between the door and a wall surface according to an embodiment of the present disclosure.

FIGS. 8A, 8B, and 8C are views illustrating an example in which, after the robot cleaner closes the door by pushing the door pad, the robot cleaner cleans a region in which the robot cleaner is positioned according to an embodiment of the present disclosure.

### DETAILED DESCRIPTION

Terms used in the specification will be briefly described, and the present disclosure will then be described in detail. In the present disclosure, an expression of “at least one of a, b, or c” may refer to “a,” “b,” or “c,” “a and b,” “a and c,” “b and c,” “all of a, b, and c,” or variations thereof.

Terms used in the present disclosure are selected as general terms that are currently widely used while considering their functions in the present disclosure. However, such terms may vary depending on the intention of those skilled in the art, judicial precedents, emergence of new technologies, or the like. In addition, in specific cases, terms arbitrarily selected by an applicant may be used, and in such cases, meanings thereof are described in detail in corresponding description portions. Therefore, the terms used in the present disclosure should be defined based on meanings of the terms and contents throughout the present disclosure rather than simple names of the term.

A term of a singular number may include its plural number unless explicitly indicated otherwise in the context. Terms used herein, including technical or scientific terms, may have the same meanings as those generally understood by those skilled in the art described in the specification. In addition, terms including ordinal numbers such as “first” or “second” used herein may be used to describe various components. However, these components should not be limited by such terms. The terms are used only for distinguishing one component from another component.

Throughout the specification, when a certain component is described as “including” another component, it indicates that the certain component may further include another component rather than excluding the another component unless explicitly stated otherwise. In addition, terms such as “unit” or “module” described in the specification refer to a unit for processing at least one function or operation, and may be implemented as hardware, software, or a combination of hardware and software.

A term “and/or” includes combinations of a plurality of related listed components or any one of a plurality of related listed components.

Meanwhile, various elements and regions in the drawings are schematically illustrated. Accordingly, the spirit of the present disclosure is not limited by relative sizes or distances illustrated in the accompanying drawings.

Hereinafter, the present disclosure is described with reference to the accompanying drawings.

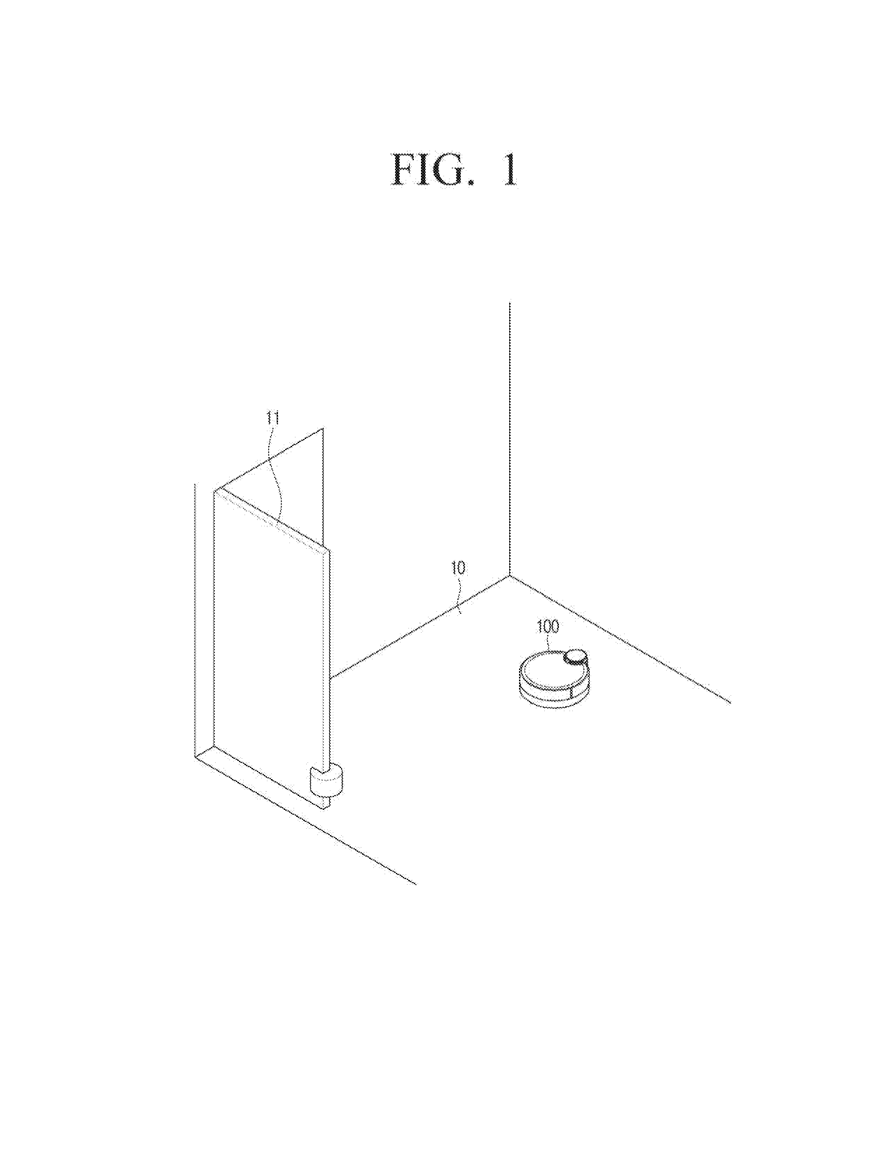

FIG. 1 is a view schematically illustrating a robot cleaner according to an embodiment of the present disclosure.

Referring to FIG. 1, a robot cleaner 100 may move in a space and perform a cleaning operation.

Movement of the robot cleaner 100 may include detecting a position of the robot cleaner 100 and a surrounding object by exploring surroundings of the robot cleaner 100, and autonomously moving within the space based on the detected information. The movement may be replaced by an expression such as traveling, for example.

The space may include various indoor spaces such as, for example, a house, an office, a hotel, a factory, a shop, a mart, and a restaurant. In addition, the object may include various types of obstacles present in an indoor space in which the robot cleaner 100 is positioned, such as, for example, a wall, furniture, or a home appliance.

The cleaning operation may include vacuuming foreign substances such as dust on a floor while the robot cleaner 100 moves in the space, and wiping the floor by using a mop or the like.

The space may include a plurality of regions. A region may be distinguished from another region by a wall. In addition, a region may be connected to another region through an entrance, and a door may be installed in the entrance of the region. For example, when the space corresponds to a home, the region may correspond to a kitchen, a living room, a room, a restroom, or the like.

In an embodiment, when a door 11 of a region 10 in which the robot cleaner 100 is positioned is in an opened state, the robot cleaner 100 may perform cleaning of the region 10 after closing the door 11. As described above, the robot cleaner 100 may clean the region in a state in which the door is closed, thereby cleaning a space between the door and a wall surface, and reducing noise caused by cleaning that is transmitted to a person outside the region.

Specific operations in which the robot cleaner 100 closes the door are described in more detail with reference to the drawings described below and corresponding descriptions thereof.

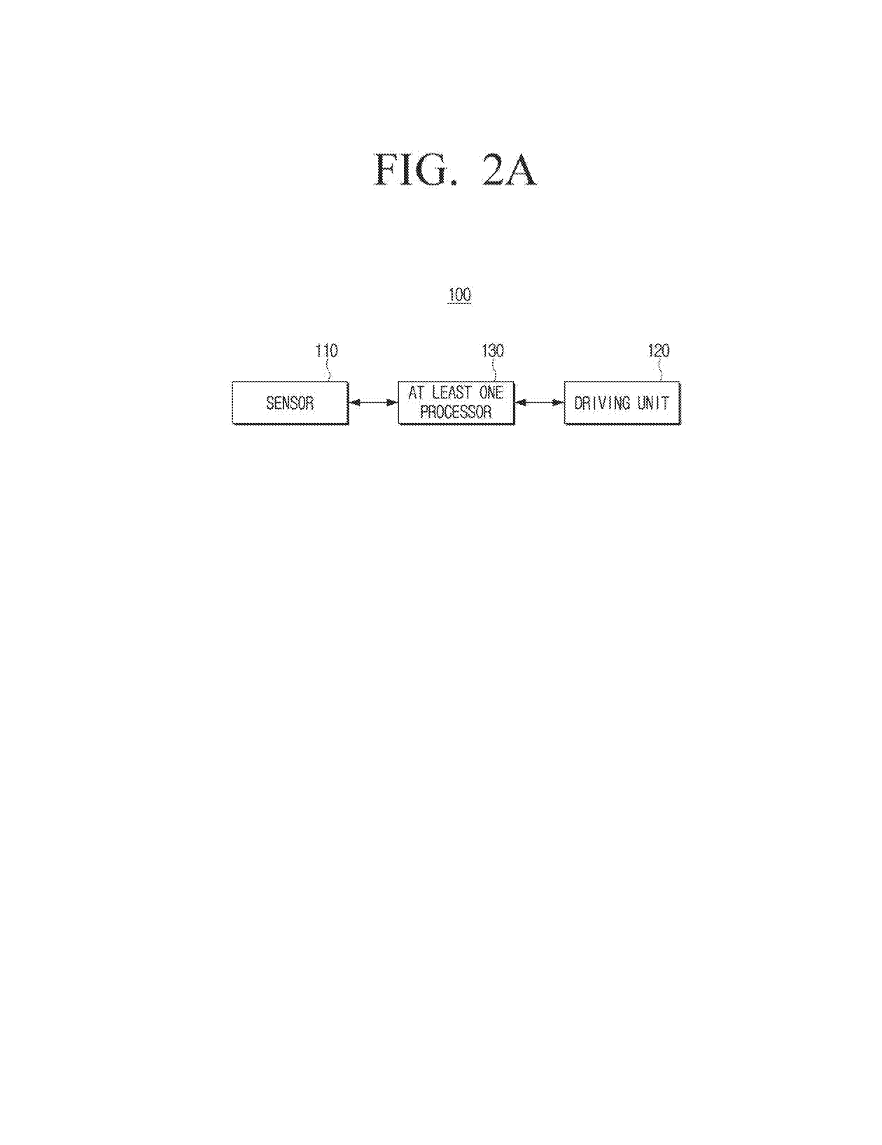

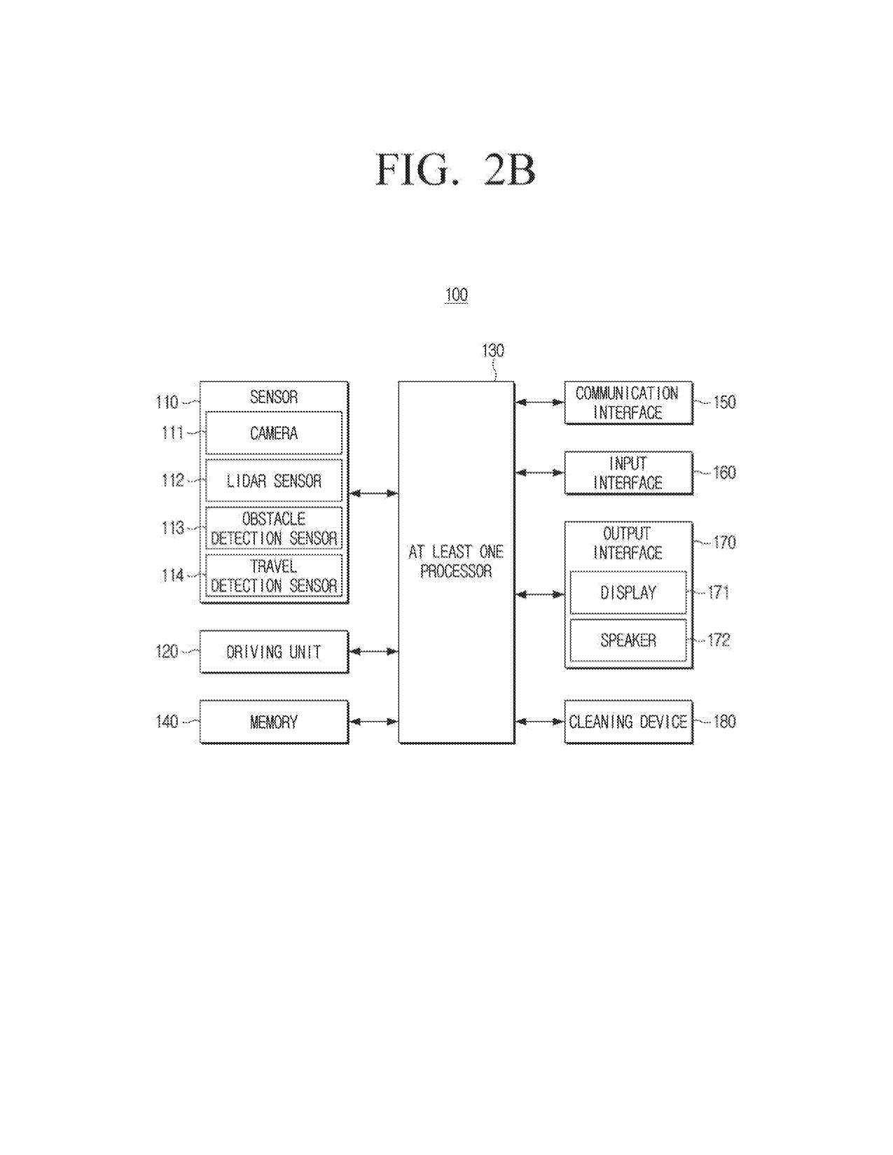

FIG. 2A is a block diagram illustrating a configuration of the robot cleaner according to an embodiment of the present disclosure.

Referring to FIG. 2A, the robot cleaner 100 may include a sensor 110, a driving unit 120 (or driver 120), and at least one processor 130. Meanwhile, the configuration of the robot cleaner 100 illustrated in FIG. 2A is merely an embodiment, and additional components may be added in some embodiments.

The sensor 110 is a component for sensing information about a surrounding environment of the robot cleaner 100. At least one processor 130 may acquire the information about the surrounding environment of the robot cleaner 100 based on sensing values acquired from the sensor 110.

In an example, the sensor 110 may include at least one camera. At least one processor 130 may acquire an image by capturing surroundings of the robot cleaner 100 (e.g., a front of the robot cleaner 100) by using the camera. For example, the camera may include a red-green-blue (RGB) camera, a depth camera, or the like. The depth camera may be implemented in a stereo manner or a time-of-flight (TOF) manner.

In an example, the sensor 110 may include a light detection and ranging (LiDAR) sensor. The LiDAR sensor may output lasers in a 360-degree direction, and when a laser reflected from an object is received, the LiDAR sensor may analyze a time difference taken for the laser to be reflected from the object and returned and a signal strength of the received laser or the like, thereby acquiring geometry information of the space. The geometry information may include the position, distance, and direction of the surrounding object of the robot cleaner 100. The LiDAR sensor may provide the acquired information to at least one processor 130.

At least one processor 130 may acquire position information of the surrounding object of the robot cleaner 100 from the sensor 110. The position information of the object may include a distance between the robot cleaner 100 and the object, a direction of the object, and the like.

In an example, at least one processor 130 may acquire an image from a camera, input the acquired image into an artificial intelligence model, identify the object, and acquire the position information of the object.

In an example, at least one processor 130 may acquire depth information from the camera, and may acquire the position information of the object based on the depth information.

In an example, at least one processor 130 may acquire the position information of the object from the LiDAR sensor.

The driving unit 120 may control movement of the robot cleaner 100 under control of at least one processor 130.

In an example, the driving unit 120 may move the robot cleaner 100, stop the robot cleaner 100 during movement, and control the movement direction, movement speed, and the like of the robot cleaner 100.

For example, the driving unit 120 may include a plurality of wheels and at least one wheel motor. The wheel motor may control the rotation direction and rotation speed of the wheel, thereby controlling the movement direction, movement speed, and the like of the robot cleaner 100. For example, when the robot cleaner 100 includes two wheels (e.g., a left wheel and a right wheel), the wheel motor may include a left wheel motor for controlling the rotation direction and movement speed of the left wheel and a right wheel motor for controlling the rotation direction and movement speed of the right wheel.

At least one processor 130 may control overall operations of the robot cleaner 100. For example, at least one processor 130 may control the overall operations of the robot cleaner 100 for closing a door of a region and cleaning the region by executing at least one instruction stored in a memory of the robot cleaner 100.

At least one processor 130 may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. At least one processor 130 may control one or any combination of other components included in the robot cleaner 100, and may perform an operation related to communication or data processing. At least one processor 130 may execute at least one program or instruction stored in the memory of the robot cleaner 100. For example, at least one processor 130 may perform a method according to an embodiment of the present disclosure by executing at least one instruction stored in the memory of the robot cleaner 100.

When the method according to an embodiment of the present disclosure includes a plurality of operations, the plurality of operations may be performed by one processor or may be performed by a plurality of processors. For example, when a first operation, a second operation, and a third operation are performed using the method according to an embodiment, all of the first operation, the second operation, and the third operation may be performed by a first processor, or the first operation and the second operation may be performed by the first processor (e.g., a general-purpose processor) and the third operation may be performed by a second processor (e.g., an artificial-intelligence-dedicated processor).

At least one processor 130 may be implemented as a single-core processor including a single core, or may be implemented as at least one multicore processor including multiple cores (for example, homogeneous multiple cores or heterogeneous multiple cores). When at least one processor 130 is implemented as the multicore processor, each of the multiple cores included in the multicore processor may include a processor internal memory such as a cache memory and an on-chip memory, and a common cache shared by the multiple cores may be included in the multicore processor. In addition, each of the multiple cores included in the multicore processor (or some of the multiple cores) may independently read and execute program instructions for implementing the method according to an embodiment of the present disclosure, or all of the multiple cores (or some of the multiple cores) may operate in association with each other to read and execute the program instructions for implementing the method according to an embodiment of the present disclosure.

When a method according to an embodiment of the present disclosure includes a plurality of operations, the plurality of operations may be performed by the single core among the multiple cores included in the multicore processor or may be performed by the multiple cores. For example, when a first operation, a second operation, and a third operation are performed by the method according to an embodiment, all of the first operation, the second operation, and the third operation may be performed by a first core included in the multicore processor, or the first operation and the second operation may be performed by the first core included in the multicore processor and the third operation may be performed by a second core included in the multicore processor.

In an embodiments of the present disclosure, the processor may refer to a system-on-chip (SoC) in which at least one processor and other electronic components are integrated with each other, the single-core processor, the multicore processor, or the core included in the single-core processor or the multicore processor. Here, the core may be implemented as the CPU, the GPU, the APU, the MIC, the DSP, the NPU, the hardware accelerator, the machine learning accelerator, or the like. However, the embodiments of the present disclosure are not limited thereto.

FIG. 2B is a block diagram illustrating a configuration of the robot cleaner according to an embodiment of the present disclosure.

Referring to FIG. 2B, the robot cleaner 100 may include the sensor 110, the driving unit 120, at least one processor 130, a memory 140, a communication interface 150, an input interface 160, an output interface 170, and a cleaning device 180. However, such a configuration is exemplary, and in implementing the present disclosure, new components may be added thereto in addition to such a configuration, or some components may be omitted therefrom. Meanwhile, among the components illustrated in FIG. 2B, detailed descriptions of components overlapping with the components illustrated in FIG. 2A are omitted.

The sensor 110 may detect a space structure or an object. Information acquired from the sensor 110 may be used to generate a map of the space.

The sensor 110 may include a camera 111 and a LiDAR sensor 112. In addition, the sensor 110 may include at least one of an obstacle detection sensor 113 or a travel detection sensor 114.

The obstacle detection sensor 113 may detect the surrounding object of the robot cleaner 100. For example, the obstacle detection sensor may include at least one of an ultrasonic sensor, an infrared sensor, a radio frequency (RF) sensor, a geomagnetic sensor, or a position sensitive device (PSD) sensor. The obstacle detection sensor 113 may detect an object present in front of, at rear of, on a side of, or on a movement path of the robot cleaner 100. The obstacle detection sensor 113 may provide information about the detected object to at least one processor 130.

The travel detection sensor 114 may detect traveling of the robot cleaner 100. For example, the travel detection sensor 114 may include at least one of a gyro sensor, a wheel encoder, or an acceleration sensor. The gyro sensor may detect the rotation direction and rotation angle of the robot cleaner 100. The wheel encoder may detect the number of rotations of wheels included in the robot cleaner 100. The acceleration sensor may detect a change in a speed of the robot cleaner 100. The travel detection sensor 114 may provide the detected traveling information to at least one processor 130.

The memory 140 may store instructions, data structures, and program codes. Operations performed by at least one processor 130 may be implemented by executing the instructions or codes of the program stored in the memory 140.

The memory 140 may include a flash memory type, a hard disk type, a multimedia card micro type, a card-type memory (e.g., a secure digital (SD) memory or an extreme digital (xD) memory), a non-volatile memory including at least one of a read-only memory (ROM), an electrically erasable programmable read-only memory (EEPROM), a programmable read-only memory (PROM), a magnetic memory, a magnetic disk, or an optical disk, and a volatile memory such as a random access memory (RAM) or a static random access memory (SRAM).

The memory 140 may store at least one instruction and/or program for causing the robot cleaner 100 to perform the operations for closing a door of a region and cleaning the region.

The communication interface 150 may perform data communication with an electronic apparatus under control of at least one processor 130. The electronic apparatus may include a server, a home appliance, a mobile device (e.g., a smartphone, a tablet personal computer (PC), or a wearable device), or the like.

For example, the communication interface 150 may include a communication circuit capable of performing data communication between the robot cleaner 100 and the electronic apparatus by using at least one of data communication schemes including a wired local region network, a wireless local region network (wireless LAN), wireless fidelity (Wi-Fi), Wi-Fi Direct, Bluetooth, ZigBee, Wi-Fi Direct (WFD), infrared communication (Infrared Data Association (IrDA)), Bluetooth low energy (BLE), near field communication (NFC), wireless broadband internet (Wibro), world interoperability for microwave access (WiMAX), shared wireless access protocol (SWAP), wireless gigabit alliances (WiGig), or radio frequency (RF) communication.

The input interface 160 may include circuitry. The input interface 160 may receive a user input and transmit the user input to at least one processor 130. For example, the input interface 160 may receive various user inputs for setting or selecting various functions supported by the robot cleaner 100.

The input interface 160 may include various types of input devices.

In an example, the input interface 160 may include a physical button. The physical button may include a function key or a dial button. The physical button may be implemented as at least one key.

In an example, the input interface 160 may receive a user input by using a touch scheme. For example, the input interface 160 may be implemented as a touch screen capable of performing a function of a display 171.

In an example, the input interface 160 may receive a user voice through a microphone. At least one processor 130 may perform a function corresponding to the user voice based on voice recognition. For example, at least one processor 130 may convert the user voice into text data by using a speech-to-text (STT) function, acquire control command data based on the text data, and perform the function corresponding to the user voice based on the control command data. In some embodiments, the STT function may be performed by an external server.

The output interface 170 may include the display 171 and a speaker 172.

The display 171 may display various screens. At least one processor 130 may display, on the display 171, various notifications, messages, information, and the like related to operations of the robot cleaner 100.

The display 171 may be implemented as a display including a self-emitting element or a display including a non-self-emitting element and a backlight. For example, the display 171 may be implemented as various types of displays such as a liquid crystal display (LCD), an organic light-emitting diode (OLED) display, a light-emitting diode (LED) display, a micro light-emitting diode (micro LED) display, a mini light-emitting diode (Mini LED) display, or a quantum dot light-emitting diode (QLED) display.

The speaker 172 may output an audio signal. At least one processor 130 may output, through the speaker 172, a warning sound, a notification message, a response message corresponding to a user input, and the like related to the operations of the robot cleaner 100.

The cleaning device 180 may include a device for cleaning a floor. For example, the cleaning device 180 may include a cleaning module for sweeping dust on a floor and vacuuming the dust, a mop module for performing mop cleaning, or the like. At least one processor 130 may control the cleaning device 180 to allow the robot cleaner 100 to vacuum foreign substances on a floor and to perform the mop cleaning while the robot cleaner 100 is stopped or while the robot cleaner 100 moves.

At least one processor 130 may perform simultaneous localization and mapping (SLAM).

In an example, at least one processor 130 may generate a map of a space based on information acquired from the LiDAR sensor 112. In addition, at least one processor 130 may acquire geometry information of the space from the LiDAR sensor 112, and compare the acquired geometry information with prestored geometry information or compare the acquired geometry information to each other, thereby identifying a position (e.g., coordinate values) of the robot cleaner 100 on the map.

In an example, at least one processor 130 may explore a space by using the camera 111, thereby generating a map of the space. In addition, at least one processor 130 may identify a position of the robot cleaner 100 on the map based on an image acquired from the camera 111.

At least one processor 130 may control traveling of the robot cleaner 100 based on the information acquired from the sensor 110.

For example, at least one processor 130 may control the driving unit 120 to move the robot cleaner 100 in a space based on a map stored in the memory 140. In addition, at least one processor 130 may acquire information from the sensor 110 while the robot cleaner 100 travels in the space, and may detect the surrounding object of the robot cleaner 100 based on the acquired information. When the object is detected, at least one processor 130 may control the driving unit 120 to allow the robot cleaner 100 to travel while avoiding the object.

Hereinafter, for convenience of description, at least one processor 130 is described as the processor 130.

For example, when a mode of the robot cleaner 100 is a cleaning mode, the processor 130 may control the driving unit 120 to move the robot cleaner 100 in a space, and may control the cleaning device 180 to allow the robot cleaner 100 to perform cleaning of the space while the robot cleaner 100 moves in the space.

The robot cleaner 100 may enter a region through an entrance of the region to clean the region of the space. In this case, a door installed in the entrance of the region may be in an opened state. The processor 130 may identify whether a door pad is attached to the door installed in the entrance when the robot cleaner 100 moves to the region. In addition, when the door pad attached to the door is identified, the processor 130 may change a mode of the robot cleaner 100 to a door opening/closing mode, and may control the driving unit 120 to allow the robot cleaner 100 to close the door in the door opening/closing mode. When the door is identified as being closed, the processor 130 may change the mode of the robot cleaner 100 to the cleaning mode, and may control the robot cleaner 100 to clean the region.

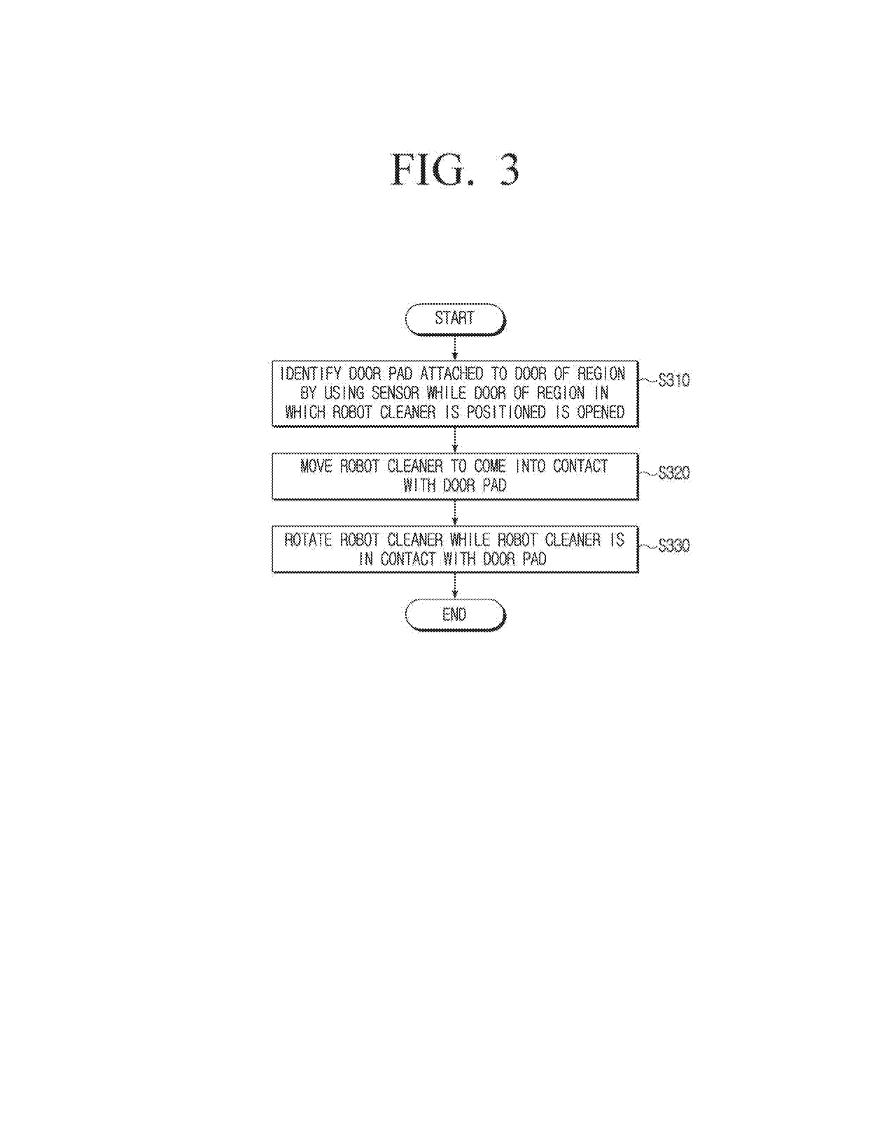

FIG. 3 is a flowchart illustrating an operation in which the robot cleaner closes a door due to rotation of the robot cleaner according to an embodiment of the present disclosure.

In operation S310, the processor 130 may identify a door pad attached to a door of a region by using the sensor 110 when the door of the region in which the robot cleaner 100 is positioned is in the opened state.

For example, the processor 130 may acquire an image in which the door is captured by capturing images of the surroundings of the robot cleaner 100 by using the camera 111. In addition, the processor 130 may identify the door pad attached to a lower region of the door based on the acquired image.

The door may be hinge-coupled to the entrance, and may be rotated about a rotation axis to open or close the entrance.

The door may be hinge-coupled to the left side or right side of the entrance. For example, when the door is hinge-coupled to the left side of the entrance, the door may be rotated about the left side of the entrance to open or close the entrance. In addition, when the door is hinge-coupled to the right side of the entrance, the door may be rotated about the right side of the entrance to open or close the entrance.

The door pad may be attached to the lower region of a door. For example, the lower region of the door may be a region having a predetermined height from a floor. In an embodiment, the robot cleaner 100 may push the door pad to allow the door having the door pad attached thereto be opened or closed, and a height at which the door pad is attached may thus be determined based on a size (e.g., a height) of the robot cleaner 100.

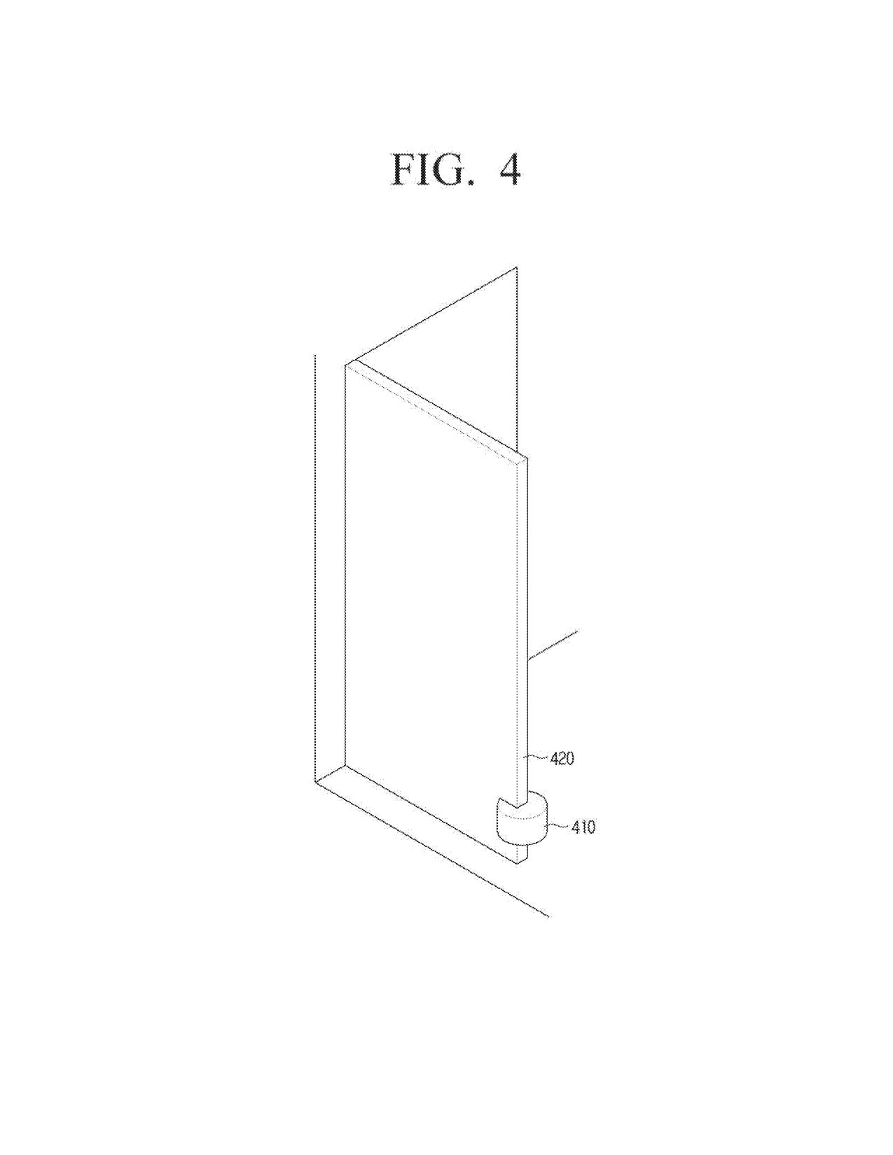

For example, referring to FIG. 4, a door pad 410 may be attached to a door 420 by surrounding a portion of each of the front surface, side surface, and rear surface of the door 420 at a lower region of the door 420. In this case, the door pad may be attached to the door by a magnetic scheme, an adhesive (or bonding) scheme, a pressing scheme, or the like.

In an example, a quick response (QR) code may be attached to the door pad. The processor 130 may acquire an image in which the surroundings of the robot cleaner 100 are captured by using the camera 111. In addition, the processor 130 may identify the door pad in the image acquired from the camera 111 based on QR code recognition, and may acquire an image in which the door pad is captured.

In an example, the door pad may include a radio frequency identification (RFID) tag, and the communication interface 150 may include an RFID reader. The processor 130 may identify whether the door pad is present around the robot cleaner 100 based on identification information received from the RFID tag through the RFID reader, and may acquire the image in which the door pad is captured from the camera 111.

In an example, the processor 130 may identify the door pad attached to the door by inputting the image acquired from the camera 111 into the artificial intelligence model.

An artificial intelligence model may be stored in the memory 140. The artificial intelligence model may include a neural network model trained to recognize a door and a door pad attached to the door in an image. The artificial intelligence model may output a probability value in which an object detected in an input image is inferred as a door or a door pad attached to the door. For example, the artificial intelligence model may include a neural network model including parameters trained by applying, as input data, images in which a door having a door pad attached thereto is captured and applying the door and the door pad as output values. The processor 130 may acquire a probability value from the artificial intelligence model by inputting an image acquired from the camera 111 into the artificial intelligence model, and may identify whether the door and the door pad attached to the door are present in the image acquired from the camera 111 by comparing the probability value with a predetermined value.

In operation S320, when the door pad attached to the door is identified, the processor 130 may control the driving unit 120 to move the robot cleaner 100 to come into contact with the door pad.

In an example, when a door pad is detected in an image acquired from the camera 111, the processor 130 may acquire position information of the door pad based on the acquired image.

In an example, the processor 130 may acquire the position information of the door pad detected in the image from the LiDAR sensor.

The position information of the door pad may include information about a distance between the robot cleaner 100 and the door pad, a direction of the door pad, and the like.

In addition, the processor 130 may control the driving unit 120 to move the robot cleaner 100 to come into contact with the door pad based on the acquired position information. The robot cleaner 100 coming into contact with the door pad may include a portion of a body of the robot cleaner 100 coming into contact with the door pad. The contact may be replaced by an expression such as close contact, for example.

For example, the processor 130 may identify, on the map, a position at which the robot cleaner 100 is capable of coming into contact with the door pad based on a position of the robot cleaner 100, the position information of the door pad, and a size (e.g., a radius) of the robot cleaner 100, and may control the driving unit 120 to move the robot cleaner 100 to the identified position.

In this case, when the robot cleaner 100 comes into contact with the door pad, the processor 130 may control the driving unit 120 to move the robot cleaner 100 toward the door pad, and to bring a front surface of the body of the robot cleaner 100 into contact with the door pad.

As described below, after coming into contact with the door pad, the robot cleaner 100 may rotate to allow the door having the door pad attached thereto to be rotated. To capture a rotating door by using the camera 111 that captures a front of the robot cleaner 100, the processor 130 may move the robot cleaner 100 to bring the front surface of the body of the robot cleaner 100 into contact with the door pad.

In operation S330, the processor 130 may control the driving unit 120 to rotate the robot cleaner 100 while the robot cleaner 100 is in contact with the door pad to allow the door to be rotated due to rotation of the robot cleaner 100.

For example, the processor 130 may identify a position at which a door is installed in an entrance based on an image in which the door is captured.

The position at which the door is installed in the entrance indicates a position at which the door is attached to the entrance with reference to the robot cleaner 100 in the region. For example, the position at which the door is installed in the entrance may be the left side or right side of the entrance with reference to the robot cleaner 100.

In an example, the processor 130 may identify that a door is installed on a left side of an entrance when the entrance is disposed on a right side of the door in the opened state in an image acquired from the camera 111, and the processor 130 may identify that a door is installed on a right side of an entrance when the entrance is disposed on a left side of the door in the opened state.

In addition, the processor 130 may control the driving unit 120 to rotate the robot cleaner 100 in a rotation direction corresponding to the identified position while the robot cleaner 100 is in contact with the door pad.

For example, when the door is installed on the left side of the entrance, the processor 130 may control the driving unit 120 to rotate the robot cleaner 100 in a clockwise direction while the robot cleaner 100 is in contact with the door pad. In addition, when the door is installed on the right side of the entrance, the processor 130 may control the driving unit 120 to rotate the robot cleaner 100 in a counterclockwise direction while the robot cleaner 100 is in contact with the door pad. In this case, the processor 130 may control the driving unit 120 to gradually increase the rotation speed of the robot cleaner 100.

When the robot cleaner 100 rotates after coming into contact with the door pad, the door may be rotated about the rotation axis due to friction occurring between the robot cleaner 100 and the door pad. The rotation axis of the door indicates a position at which the door is installed in an entrance, and in this case, a rotation direction of the door may be a direction in which the door is closed. For example, the door may be rotated in the counterclockwise direction when the robot cleaner 100 rotates in the clockwise direction, and the door may be rotated in the clockwise direction when the robot cleaner 100 rotates in the counterclockwise direction.

The processor 130 may acquire an image from the camera 111 while the robot cleaner 100 rotates, track the door pad included in the acquired image, and identify whether the door is rotated due to rotation of the robot cleaner 100.

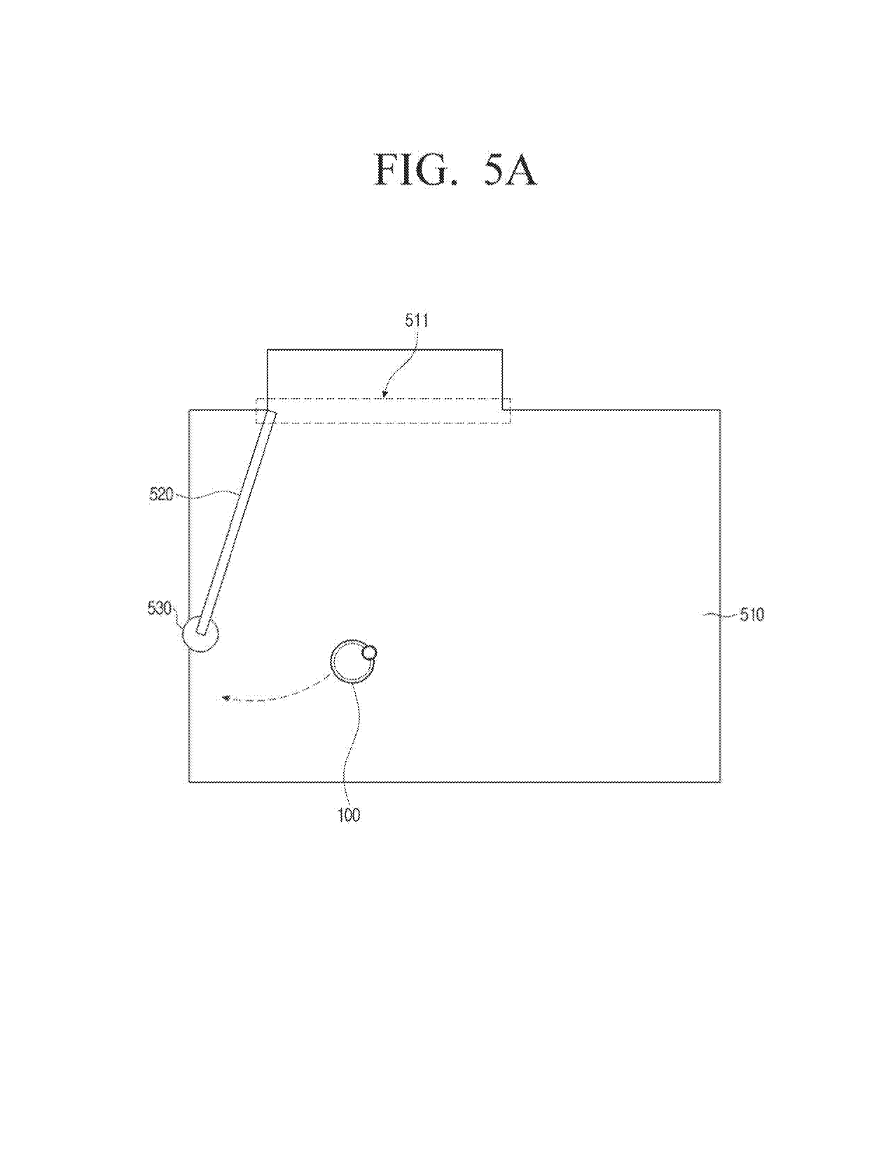

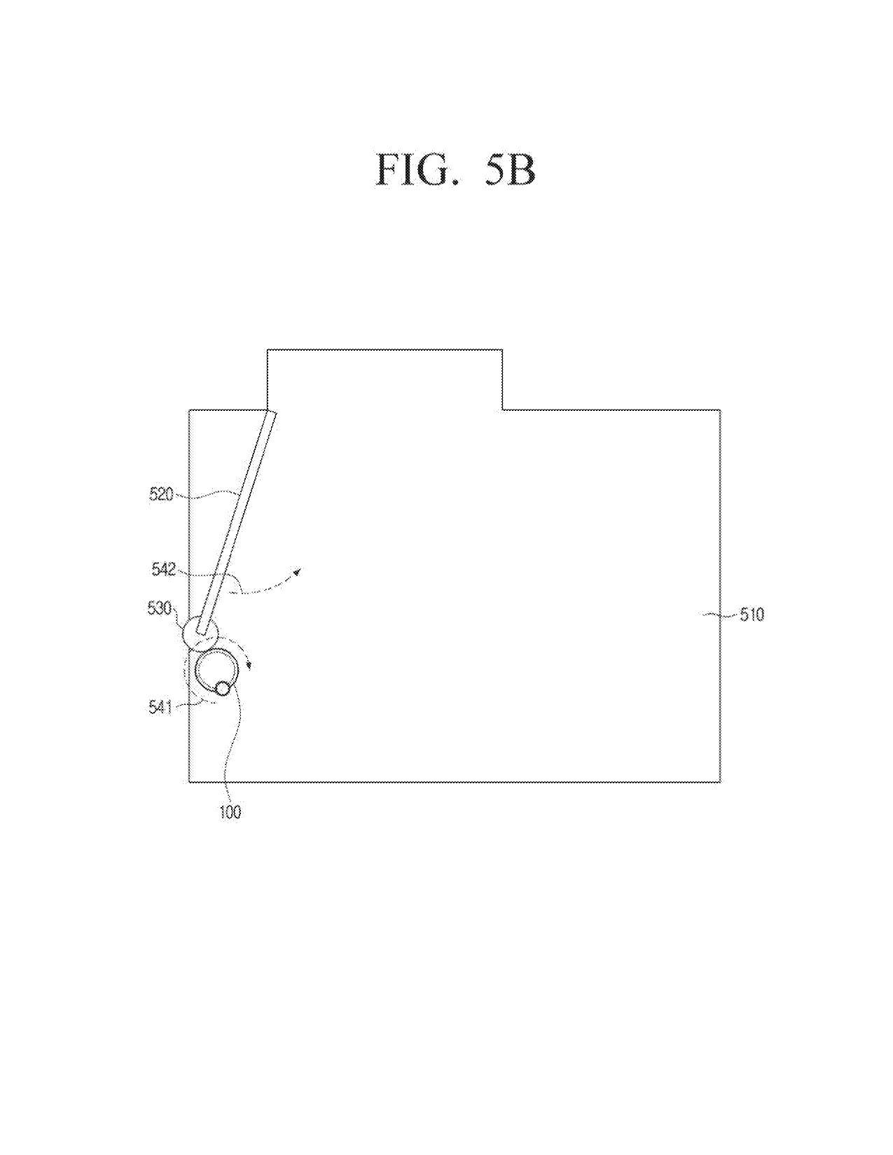

FIGS. 5A and 5B are views illustrating an example of an operation in which the robot cleaner rotates the door due to rotation of the robot cleaner according to an embodiment of the present disclosure.

Referring to FIG. 5A, the robot cleaner 100 may move into a region 510 through an entrance 511 of the region 510. In addition, the robot cleaner 100 may identify a door pad 530 attached to a door 520 in the region 510, move to the door pad 530, and come into contact with the door pad 530. Referring to FIG. 5B, after coming into contact with the door pad 530, the robot cleaner 100 may rotate in a clockwise direction 541 in place. In this case, the door 520 may be rotated in a counterclockwise direction 542 by friction occurring between the robot cleaner 100 and the door pad 530 due to rotation of the robot cleaner 100. In addition, the robot cleaner 100 may acquire an image from the camera 111 while the robot cleaner 100 rotates, and may identify whether the door pad 530 is rotated based on the acquired image.

As described above, the door may be rotated about the rotation axis due to rotation of the robot cleaner 100. The processor 130 may control the driving unit 120 to move the robot cleaner 100 into a space between the door and a wall surface formed by rotation of the door, and may control the driving unit 120 to allow the robot cleaner 100 to push the door pad after the robot cleaner 100 moves into the space between the door and the wall surface. Accordingly, the door may be closed.

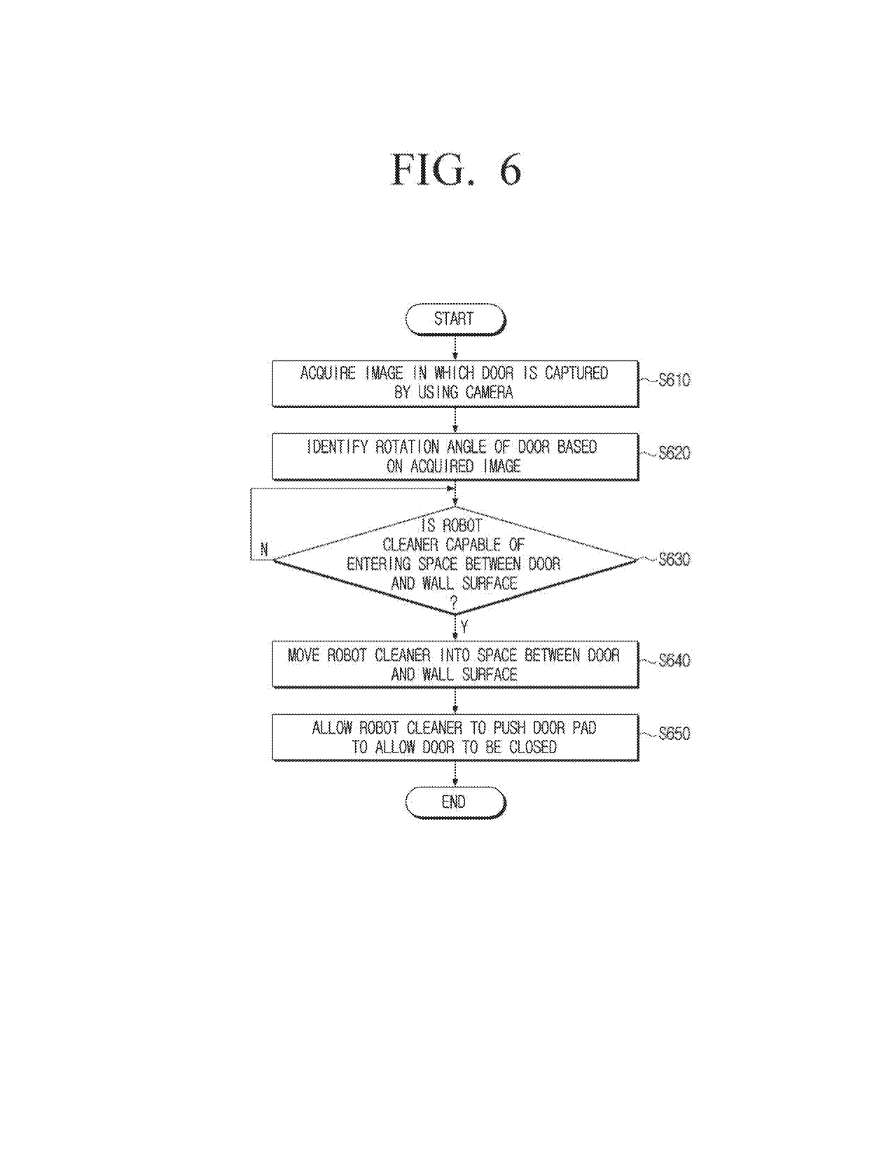

FIG. 6 is a flowchart illustrating an operation in which the robot cleaner closes the door by pushing the door pad attached to the door after rotation of the door according to an embodiment of the present disclosure.

In operations S610 and S620, the processor 130 may acquire an image in which a door is captured by using the camera 111, and may identify a rotation angle of the door based on the acquired image.

For example, when an angle of the door is 0° in a state in which the door is closed, a rotation angle of the door may include an angle in which the door is rotated with reference to the state in which the door is closed.

The processor 130 may identify the rotation angle of the door by inputting an image acquired from the camera 111 into the artificial intelligence model.

The artificial intelligence model may be stored in the memory 140. The artificial intelligence model may include a neural network model trained to identify a rotation angle of a door included in an image. The artificial intelligence model may output information about the rotation angle of a door identified in an input image. For example, the artificial intelligence model may include a neural network model including parameters trained by applying images in which a door opened at various angles is captured as the input data and applying the rotation angle of the door as an output value. Accordingly, the processor 130 may acquire the information about a rotation angle of a door from the artificial intelligence model by inputting an image acquired from the camera 111 into the artificial intelligence model, and may identify the rotation angle of the door.

In operation S630, the processor 130 may identify whether the robot cleaner 100 is capable of entering a space between a door and a wall surface based on the identified rotation angle.

The memory 140 may store information about distances between a door and a wall surface respectively corresponding to a plurality of rotation angles. For example, in a stage of manufacturing the robot cleaner 100, the distances between a door and a wall surface respectively corresponding to the plurality of rotation angles of the door may be measured, and information about the plurality of distances measured with respect to the plurality of rotation angles may be stored in the memory 140.

The processor 130 may identify, among the plurality of distances corresponding to the plurality of rotation angles, a distance corresponding to the identified rotation angle based on the information stored in the memory 140, and may identify whether the robot cleaner 100 is capable of entering a space between a door and a wall surface based on the identified distance.

For example, when a distance between a door and a wall surface is greater than the size (e.g., the diameter) of the robot cleaner 100, the processor 130 may identify that the robot cleaner 100 is capable of entering the space between the door and the wall surface. In addition, when the distance between the door and the wall surface is equal to or less than the size (e.g., the diameter) of the robot cleaner 100, the processor 130 may identify that the robot cleaner 100 is not capable of entering the space between the door and the wall surface.

In operations S630-Y and S640, the processor 130 may control the driving unit 120 to move the robot cleaner 100 into the space between the door and the wall surface when the robot cleaner 100 is identified as being capable of entering the space between the door and the wall surface.

In this case, the space between the door and the wall surface may include a space between the door pad attached to the door and the wall surface. For example, the processor 130 may control the driving unit 120 to move the robot cleaner 100 into the space between the door pad and the wall surface by tracking the door pad based on an image acquired from the camera 111.

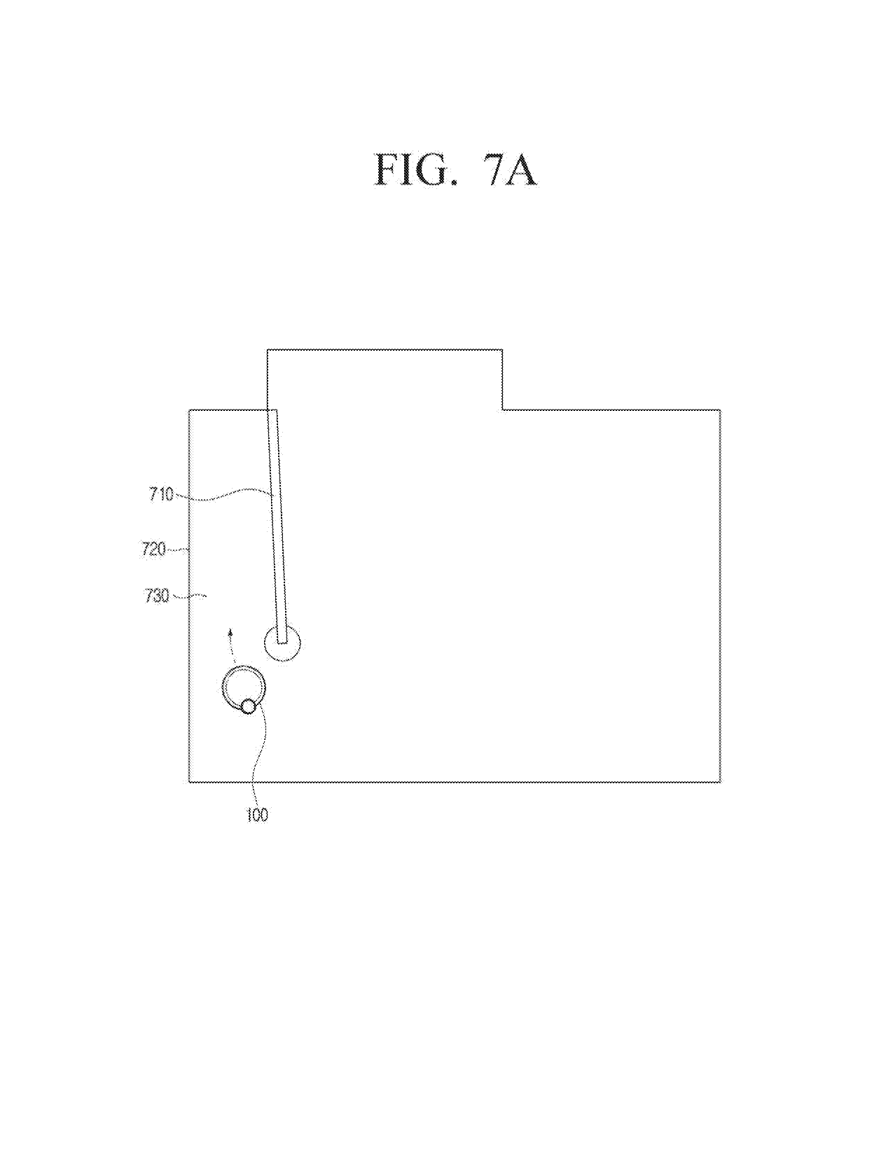

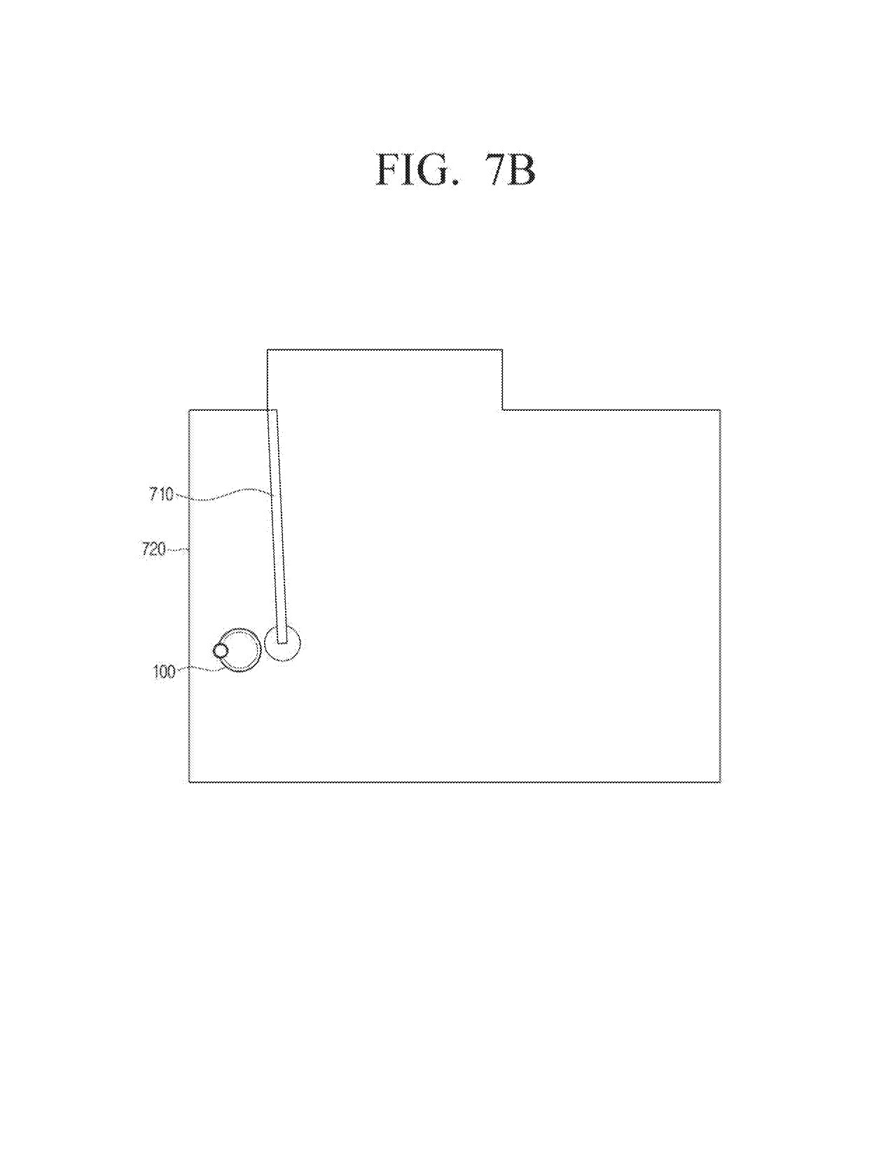

For example, referring to FIGS. 7A and 7B, a door 710 may be rotated by rotation of the robot cleaner 100, and a space 730 may be formed between the door 710 and a wall surface 720. The robot cleaner 100 may move into the space 730.

In operation S650, the processor 130 may control the driving unit 120 to allow the robot cleaner 100 to push a door pad.

For example, the processor 130 may acquire an image in which the door is captured by using the camera 111, and may identify a size of the door based on the acquired image.

A size of the door may indicate a width of the door. The width of the door may indicate a distance between the left end and right end of the door.

In an example, the processor 130 may identify the left end and right end of the door in an image acquired from the camera 111, and may identify a distance between the robot cleaner 100 and the left end of the door and a distance between the robot cleaner 100 and the right end of the door by using the artificial intelligence model.

The processor 130 may use the LiDAR sensor to identify an angle formed between a line segment between the robot cleaner 100 and the left end of the door and a line segment between the robot cleaner 100 and the right end of the door. For example, the LiDAR sensor may output lasers in a 360-degree direction, and receive a laser reflected from an object, thereby identifying a distance to the object. In this case, the processor 130 may identify a rotation angle of the LiDAR sensor when a value equal to the distance between the robot cleaner 100 and the left end of the door is measured among the distances measured by the LiDAR sensor and, the processor 130 may identify a rotation angle of the LiDAR sensor when a value equal to the distance between the robot cleaner 100 and the right end of the door is measured. In addition, the processor 130 may identify the rotation angle of the door, as the angle formed by the line segment between the robot cleaner 100 and the left end of the door and the line segment between the robot cleaner 100 and the right end of the door, based on a difference value between the identified rotation angles.

In addition, the processor 130 may identify the size of the door based on the distance between the robot cleaner 100 and the left end of the door, the distance between the robot cleaner 100 and the right end of the door, and the angle formed by the line segment between the robot cleaner 100 and the left end of the door and the line segment between the robot cleaner 100 and the right end of the door. For example, the processor 130 may identify the size of the door according to a law of cosines.

In an example, the processor 130 may identify the size of the door by inputting an image acquired from the camera 111 into the artificial intelligence model.

The artificial intelligence model may be stored in the memory 140. The artificial intelligence model may include a neural network model trained to identify a size of a door included in an image. The artificial intelligence model may output information about the size of a door included in an input image. For example, the artificial intelligence model may include a neural network model including parameters trained by applying images in which a door is captured as input data and applying the size of a door as an output value. The processor 130 may acquire information about the size of a door from the artificial intelligence model by inputting an image acquired from the camera 111 into the artificial intelligence model.

The processor 130 may identify a movement trajectory of a door pad based on a size of the door with reference to a rotation axis of a door.

The movement trajectory of a door pad may indicate a trajectory along which the door pad moves when a door is closed.

The rotation axis of the door indicates a position at which the door is installed in an entrance, and may indicate the left side or right side of the entrance. For example, the processor 130 may acquire an image in which the door is captured by using the camera 111, and input the acquired image into the artificial intelligence model, thereby acquiring the position information of the door pad. The position information of the door pad may include the distance between the robot cleaner 100 and the door pad, the direction of the door pad, and the like. In addition, the processor 130 may identify a position (e.g., coordinate values) of the door pad on the map based on the position of the robot cleaner 100 on the map and the position information of the door pad.

In addition, the processor 130 may identify a position of the rotation axis of the door on the map based on a position of the entrance on the map and the position at which the door is installed in the entrance.

For example, when the door is installed on the left side of the entrance, the processor 130 may identify, as a position of the rotation axis of the door, a position (e.g., coordinate values) of the left side of the entrance on the map, and when the door is installed on the right side of the entrance, the processor 130 may identify, as a position of the rotation axis of the door, a position (e.g., coordinate values) of the right side of the entrance on the map.

In addition, the processor 130 may generate a circle having a center at the position of the rotation axis of the door and a radius corresponding to the size of the door, and may identify the movement trajectory of the door pad based on the generated circle. For example, the processor 130 may identify, as the movement trajectory of the door pad, a trajectory on a circumference of the generated circle from a position of the door pad to a position of the entrance. In this case, the position of the entrance indicates a position at which the door is not installed among the left side and right side of the entrance. For example, the position of the entrance may indicate the position on the right side of the entrance when the door is installed on the left side of the entrance, and the position of the entrance may indicate the position on the left side of the entrance when the door is installed on the right side of the entrance.

The processor 130 may control the driving unit 120 to move the robot cleaner 100 along the movement trajectory of the door pad. For example, the processor 130 may identify coordinate values of the movement trajectory of the door pad on the map, and may control the driving unit 120 to move the robot cleaner 100 along the identified coordinate values. In this case, the movement trajectory of the door pad may indicate a trajectory from a current position of the door pad to a position of the door pad in a state in which the door is closed. Accordingly, when the robot cleaner 100 moves along the movement trajectory of the door pad, the robot cleaner 100 may push the door pad to allow the door to be closed.

The processor 130 may acquire an image from the camera 111 while the robot cleaner 100 moves, track the door pad included in the acquired image to identify whether the door pad is moved, and identify that the door is completely closed when the door pad is no longer moved.

In addition, when the door is identified as being completely closed, the processor 130 may set a travel path for cleaning a region, and may control the robot cleaner 100 to perform cleaning of the region while the robot cleaner 100 moves along the travel path.

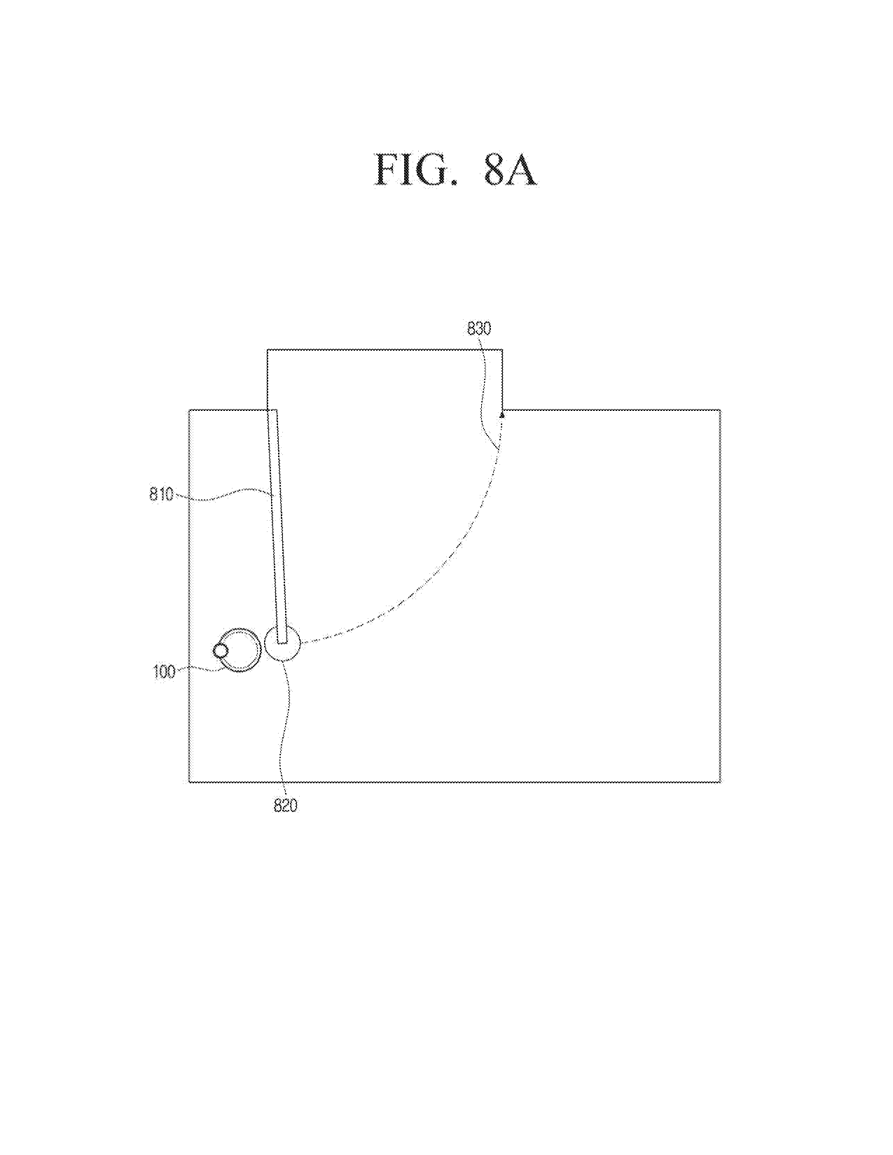

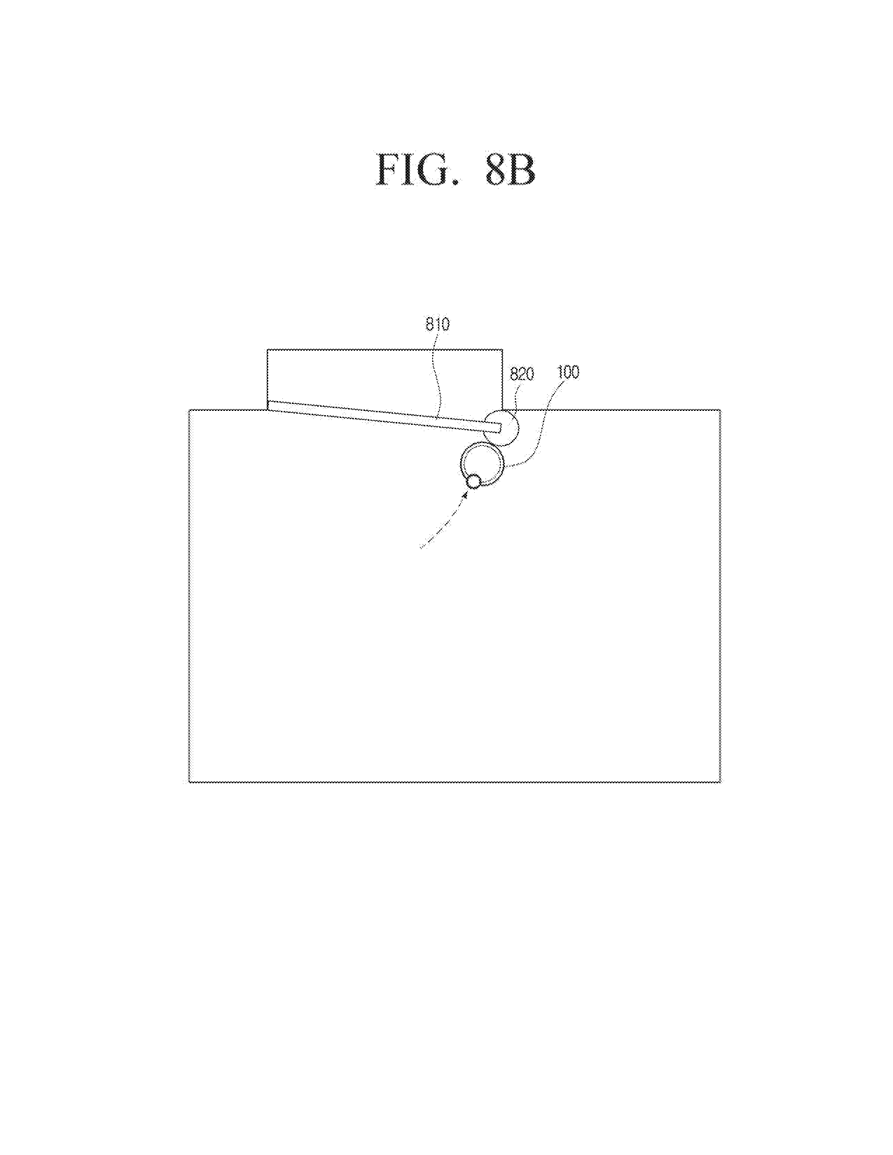

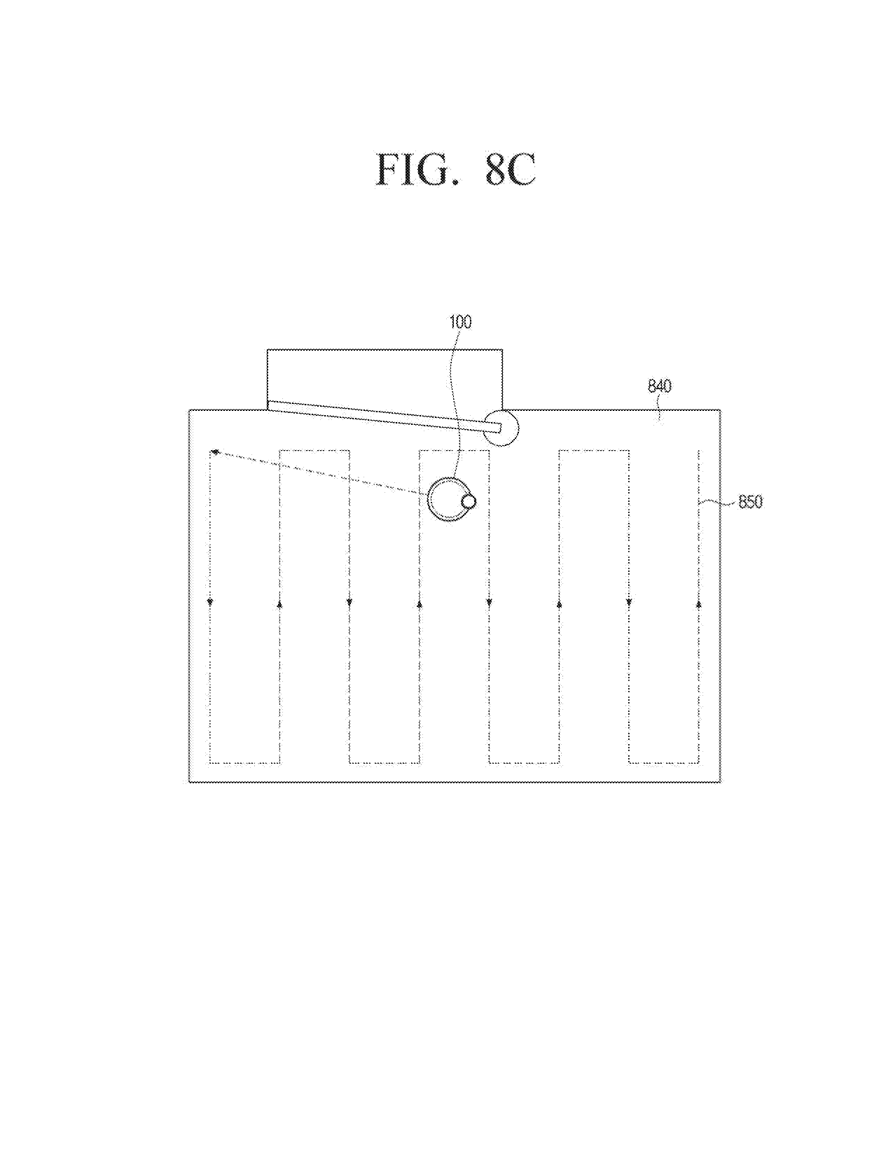

For example, referring to FIGS. 8A and 8B, the robot cleaner 100 may identify a movement trajectory 830 of a door pad 820 for closing a door 810, and may move along the movement trajectory 830. Accordingly, the robot cleaner 100 may close the door 810 by pushing the door pad 820. In addition, referring to FIG. 8C, when the door 810 is identified as being completely closed, the robot cleaner 100 may plan a travel path 850 for cleaning a region 840 in which the robot cleaner 100 is positioned, and may perform cleaning of the region 840 by using the cleaning device 180 while the robot cleaner 100 moves along the travel path 850.

Accordingly, according to the present disclosure, the robot cleaner 100 may perform cleaning of a region after closing a door, thereby cleaning a space between the door and a wall surface, and reducing noise caused by cleaning that is transmitted to a person outside the region.

Meanwhile, when cleaning of a region is completed, the processor 130 may control the driving unit 120 to allow the robot cleaner 100 to open a closed door and move outward from the region. For example, the processor 130 may control the driving unit 120 to rotate the robot cleaner 100 after the robot cleaner 100 comes into contact with the door pad. In addition, the processor 130 may control the driving unit 120 to allow the robot cleaner 100 to push the door pad after the robot cleaner 100 moves into the space between the door and the entrance that is formed by rotation of the door. Meanwhile, a method for the robot cleaner 100 to open the door is equally applicable as the method used when the robot cleaner 100 closes the door, and descriptions of specific operations in which the robot cleaner 100 opens the door are thus omitted.

Meanwhile, the neural network model according to the present disclosure refers to the artificial intelligence model including a neural network, and may be trained by deep learning. The neural network may include, for example, at least one of a convolutional neural network (CNN), a recurrent neural network (RNN), a restricted Boltzmann machine (RBM), a deep belief network (DBN), a bidirectional recurrent deep neural network (BRDNN), a generative adversarial networks (GAN), or deep Q-networks. However, the neural network model is not limited to the above-described examples.

According to an embodiment, a robot cleaner includes: a sensor; a driver; at least one memory storing instructions; and at least one processor, wherein the instructions, when executed by the at least one processor, cause the robot cleaner to: identify a door pad attached to a door by using the sensor when the door of a region in which the robot cleaner is positioned is in an opened state; control the driver to move the robot cleaner to come into contact with the door pad; and control the driver to rotate the robot cleaner while the robot cleaner is in contact with the door pad to allow the door to be rotated.

The sensor may include a camera, and wherein the instructions, when executed by the at least one processor, may cause the robot cleaner to: obtain an image in which the door is captured by using the camera; and identify the door pad attached to a lower region of the door based on the obtained image.

The sensor may include a camera, and wherein the instructions, when executed by the at least one processor, may cause the robot cleaner to: obtain an image in which the door is captured by using the camera; identify a position at which the door is installed in an entrance based on the obtained image; and control the driver to rotate the robot cleaner in a rotation direction corresponding to the identified position while the robot cleaner is in contact with the door pad.

The door may be rotated about a rotation axis due to the rotation of the robot cleaner, and wherein the instructions, when executed by the at least one processor, may cause the robot cleaner to: control the driver to move the robot cleaner into a space between the door and a wall surface formed by rotation of the door; and control the driver to allow the robot cleaner to push the door pad.

The sensor may include a camera, and wherein the instructions, when executed by the at least one processor, may cause the robot cleaner to: obtain an image in which the door is captured by using the camera; identify a rotation angle of the door based on the obtained image; identify whether the robot cleaner is physically capable of entering the space between the door and the wall surface based on the identified rotation angle; and control the driver to move the robot cleaner into the space between the door and the wall surface when the robot cleaner is identified as being physically capable of entering the space between the door and the wall surface.

The sensor may include a camera, and wherein the instructions, when executed by the at least one processor, may cause the robot cleaner to: obtain an image in which the door is captured by using the camera; identify a size of the door based on the obtained image; identify a movement trajectory of the door pad based on the size of the door with respect to the rotation axis of the door; and control the driver to allow the robot cleaner to push the door pad based on the identified movement trajectory.

The instructions, when executed by the at least one processor, may cause the robot cleaner to: generate a circle having a center at the rotation axis of the door and a radius corresponding to the size of the door; and identify, as the movement trajectory of the door pad, a trajectory on a circumference of the generated circle from a position of the door pad to a position of an entrance.

According to an embodiment, a cleaning method for a robot cleaner includes a sensor, the cleaning method including: identifying a door pad attached to a door by using the sensor when the door of a region in which the robot cleaner is positioned is in an opened state; moving the robot cleaner to come into contact with the door pad; and rotating the robot cleaner while the robot cleaner is in contact with the door pad to allow the door to be rotated.

The sensor may include a camera, and wherein the identifying of the door pad may include: obtaining an image in which the door is captured by using the camera; and identifying the door pad attached to a lower region of the door based on the obtained image.

The sensor may include a camera, and wherein the rotating of the robot cleaner may include: obtaining an image in which the door is captured by using the camera; identifying a position at which the door is installed in an entrance based on the obtained image; and rotating the robot cleaner in a rotation direction corresponding to the identified position while the robot cleaner is in contact with the door pad.

The door may be rotated about a rotation axis due to the rotation of the robot cleaner, wherein the cleaning method further may include: moving the robot cleaner into a space between the door and a wall surface formed by rotation of the door; and moving the robot cleaner to push the door pad.

The sensor may include a camera, and wherein the moving of the robot cleaner may include: obtaining an image in which the door is captured by using the camera; identifying a rotation angle of the door based on the obtained image; identifying whether the robot cleaner is physically capable of entering the space between the door and the wall surface based on the identified rotation angle; and moving the robot cleaner into the space between the door and the wall surface when the robot cleaner is identified as being physically capable of entering the space between the door and the wall surface.

The sensor may include a camera, and wherein the pushing of the door pad may include: obtaining an image in which the door is captured by using the camera; identifying a size of the door based on the obtained image; identifying a movement trajectory of the door pad based on the size of the door with respect to the rotation axis of the door; and moving the robot cleaner to push the door pad based on the identified movement trajectory.

The identifying of the movement trajectory of the door pad may include: generating a circle having a center at the rotation axis of the door and a radius corresponding to the size of the door; and identifying, as the movement trajectory of the door pad, a trajectory on a circumference of the generated circle from a position of the door pad to a position of an entrance.

The various embodiments described above may be implemented in a computer-readable recording medium or a device similar thereto that uses software, hardware, or a combination of software and hardware. In some cases, the embodiments described in the specification may be implemented by a processor itself. According to software implementation, the embodiments such as the procedures and functions described in the specification may be implemented by separate software modules. Each of the software modules may perform at least one function or operation described in the specification.

Meanwhile, computer instructions for performing processing operations of the electronic apparatus according to the various embodiments of the present disclosure described above may be stored in a non-transitory computer-readable recording medium. The computer instructions stored in the non-transitory computer-readable recording medium may allow a specific device to perform the processing operations of the robot cleaner 100 according to the various embodiments described above when the computer instructions are executed by a processor of the specific device.

The non-transitory computer-readable recording medium is not a medium that temporarily stores data, such as a register, a cache, or a memory, and indicates a medium that semi-permanently stores data and is readable by the device. A specific example of the non-transitory computer-readable recording medium may include a compact disk (CD), a digital versatile disk (DVD), a hard disk, a Blu-ray disk, a universal serial bus (USB), a memory card, a read-only memory (ROM), or the like.

Although the embodiments of the present disclosure have been shown and described hereinabove, the present disclosure is not limited to the above-mentioned specific embodiments, and may be variously modified by those skilled in the art to which the present disclosure pertains without departing from the scope and spirit of the present disclosure as disclosed in the accompanying claims. These modifications should also be understood to fall within the scope and spirit of the present disclosure.

What is claimed is:

1. A robot cleaner comprising:
a sensor;
a driver;
at least one memory storing instructions; and
at least one processor,
wherein the instructions, when executed by the at least one processor, cause the robot cleaner to:
identify a door pad attached to a door by using the sensor when the door of a region in which the robot cleaner is positioned is in an opened state;
control the driver to move the robot cleaner to come into contact with the door pad; and
control the driver to rotate the robot cleaner while the robot cleaner is in contact with the door pad to allow the door to be rotated.

2. The robot cleaner as claimed in claim 1, wherein the sensor comprises a camera, and
wherein the instructions, when executed by the at least one processor, cause the robot cleaner to:
obtain an image in which the door is captured by using the camera; and
identify the door pad attached to a lower region of the door based on the obtained image.

3. The robot cleaner as claimed in claim 1, wherein the sensor comprises a camera, and
wherein the instructions, when executed by the at least one processor, cause the robot cleaner to:
obtain an image in which the door is captured by using the camera;
identify a position at which the door is installed in an entrance based on the obtained image; and
control the driver to rotate the robot cleaner in a rotation direction corresponding to the identified position while the robot cleaner is in contact with the door pad.

4. The robot cleaner as claimed in claim 1, wherein the door is rotated about a rotation axis due to the rotation of the robot cleaner, and
wherein the instructions, when executed by the at least one processor, cause the robot cleaner to:
control the driver to move the robot cleaner into a space between the door and a wall surface formed by rotation of the door; and
control the driver to allow the robot cleaner to push the door pad.

5. The robot cleaner as claimed in claim 4, wherein the sensor comprises a camera, and
wherein the instructions, when executed by the at least one processor, cause the robot cleaner to:
obtain an image in which the door is captured by using the camera;
identify a rotation angle of the door based on the obtained image;
identify whether the robot cleaner is physically capable of entering the space between the door and the wall surface based on the identified rotation angle; and
control the driver to move the robot cleaner into the space between the door and the wall surface when the robot cleaner is identified as being physically capable of entering the space between the door and the wall surface.

6. The robot cleaner as claimed in claim 4, wherein the sensor comprises a camera, and
wherein the instructions, when executed by the at least one processor, cause the robot cleaner to:
obtain an image in which the door is captured by using the camera;
identify a size of the door based on the obtained image;
identify a movement trajectory of the door pad based on the size of the door with respect to the rotation axis of the door; and
control the driver to allow the robot cleaner to push the door pad based on the identified movement trajectory.

7. The robot cleaner as claimed in claim 6, wherein the instructions, when executed by the at least one processor, cause the robot cleaner to:
generate a circle having a center at the rotation axis of the door and a radius corresponding to the size of the door; and
identify, as the movement trajectory of the door pad, a trajectory on a circumference of the generated circle from a position of the door pad to a position of an entrance.

8. A cleaning method for a robot cleaner comprising a sensor, the cleaning method comprising:
identifying a door pad attached to a door by using the sensor when the door of a region in which the robot cleaner is positioned is in an opened state;
moving the robot cleaner to come into contact with the door pad; and
rotating the robot cleaner while the robot cleaner is in contact with the door pad to allow the door to be rotated.

9. The cleaning method as claimed in claim 8, wherein the sensor comprises a camera, and
wherein the identifying of the door pad comprises:
obtaining an image in which the door is captured by using the camera; and
identifying the door pad attached to a lower region of the door based on the obtained image.

10. The cleaning method as claimed in claim 8, wherein the sensor comprises a camera, and
wherein the rotating of the robot cleaner comprises:
obtaining an image in which the door is captured by using the camera;
identifying a position at which the door is installed in an entrance based on the obtained image; and
rotating the robot cleaner in a rotation direction corresponding to the identified position while the robot cleaner is in contact with the door pad.

11. The cleaning method as claimed in claim 8, wherein the door is rotated about a rotation axis due to the rotation of the robot cleaner,
wherein the cleaning method further comprising:
moving the robot cleaner into a space between the door and a wall surface formed by rotation of the door; and
moving the robot cleaner to push the door pad.

12. The cleaning method as claimed in claim 11, wherein the sensor comprises a camera, and
wherein the moving of the robot cleaner comprises:
obtaining an image in which the door is captured by using the camera;
identifying a rotation angle of the door based on the obtained image;
identifying whether the robot cleaner is physically capable of entering the space between the door and the wall surface based on the identified rotation angle; and
moving the robot cleaner into the space between the door and the wall surface when the robot cleaner is identified as being physically capable of entering the space between the door and the wall surface.

13. The cleaning method as claimed in claim 11, wherein the sensor comprises a camera, and
wherein the pushing of the door pad comprises:
obtaining an image in which the door is captured by using the camera;
identifying a size of the door based on the obtained image;
identifying a movement trajectory of the door pad based on the size of the door with respect to the rotation axis of the door; and
moving the robot cleaner to push the door pad based on the identified movement trajectory.

14. The cleaning method as claimed in claim 13, wherein the identifying of the movement trajectory of the door pad comprises:
generating a circle having a center at the rotation axis of the door and a radius corresponding to the size of the door; and
identifying, as the movement trajectory of the door pad, a trajectory on a circumference of the generated circle from a position of the door pad to a position of an entrance.

15. A non-transitory computer readable recording medium storing computer instructions that cause a robot cleaner to perform an operation when executed by at least one processor of the robot cleaner, wherein the operation comprises;
identifying a door pad attached to a door by using a sensor of the robot cleaner when the door of a region in which the robot cleaner is positioned is in an opened state;
moving the robot cleaner to come into contact with the door pad; and
rotating the robot cleaner while the robot cleaner is in contact with the door pad to allow the door to be rotated.

16. The medium as claimed in claim 15, wherein the sensor comprises a camera, and
wherein the identifying of the door pad comprises:
obtaining an image in which the door is captured by using the camera; and
identifying the door pad attached to a lower region of the door based on the obtained image.

17. The medium as claimed in claim 15, wherein the sensor comprises a camera, and
wherein the rotating of the robot cleaner comprises:
obtaining an image in which the door is captured by using the camera;
identifying a position at which the door is installed in an entrance based on the obtained image; and
rotating the robot cleaner in a rotation direction corresponding to the identified position while the robot cleaner is in contact with the door pad.

18. The medium as claimed in claim 15, wherein the door is rotated about a rotation axis due to the rotation of the robot cleaner,
wherein the cleaning method further comprising:
moving the robot cleaner into a space between the door and a wall surface formed by rotation of the door; and
moving the robot cleaner to push the door pad.

19. The medium as claimed in claim 18, wherein the sensor comprises a camera, and
wherein the moving of the robot cleaner comprises:
obtaining an image in which the door is captured by using the camera;
identifying a rotation angle of the door based on the obtained image;
identifying whether the robot cleaner is physically capable of entering the space between the door and the wall surface based on the identified rotation angle; and
moving the robot cleaner into the space between the door and the wall surface when the robot cleaner is identified as being physically capable of entering the space between the door and the wall surface.

20. The medium as claimed in claim 19, wherein the sensor comprises a camera, and
wherein the pushing of the door pad comprises:
obtaining an image in which the door is captured by using the camera;
identifying a size of the door based on the obtained image;
identifying a movement trajectory of the door pad based on the size of the door with respect to the rotation axis of the door; and
moving the robot cleaner to push the door pad based on the identified movement trajectory.
